(19) United States
(12) Patent Application Publication
(10) Pub. No.: US 2014/0099096 A1
(43) Pub. Date: Apr. 10, 2014

(54) CAMERA LENS ADJUSTMENT RING CONTROL

(71) Applicant: David FABREGA, Montréal (CA)

(72) Inventor: David FABREGA, Montréal (CA)

(21) Appl. No.: 14/046,162

(22) Filed: Oct. 4, 2013

(30) Foreign Application Priority Data
Oct. 5, 2012 (CA) 2791955

(51) Int. Cl. G03B 15/00

(52) U.S. Cl. CPC G03B 15/00
USPC 396/544

(57) ABSTRACT

A device and a method for facilitating the rotation of an adjustment ring from a plurality of adjustment rings of a camera lens. The device comprises a tightening ring having an adjustable diameter and a control lever protruding from the tightening ring allowing a user to rotate the adjustment ring of the camera lens along the lens' longitudinal axis. The method comprises enlarging a tightening ring to an extended diameter larger than the diameter of the adjustment ring and positioning the lever ring device onto the adjustment ring of the camera for frictionally engaging the tightening ring onto the adjustment ring. Applying lateral pressure along the camera lens' longitudinal axis onto a control lever protruding from the tightening ring causes the adjustment ring to rotate.

### TECHNICAL FIELD

The invention relates to a camera accessory and, more specifically, a camera accessory for a camera lens.

### BACKGROUND

For a fraction of the price, SLR cameras provide similar quality and resolution as regular cameras designed and used exclusively for capturing video. For this reason, it is not surprising that they are increasingly being used by video production companies to capture high-quality video.

However, when recording video, the zoom and focal controls of an SLR camera cannot be rapidly adjusted by hand. Two adjustment rings must be rotated one at a time with the left hand, one to adjust the zoom and another for the focus. A user first adjusts the zoom ring to set the enlargement of an image as seen through the lens of a digital SLR camera, then moves their hand away to adjust the focus ring while the right hand holds the camera near the camera trigger. Such an adjustment delay is too long when live events are being captured, as is often the case in journalism or documentary filmmaking. Additionally, the fact that most SLR cameras lack an auto-focus and auto-zoom functions present only on cameras designed exclusively for video reinforces the need to optimize the ergonomics of SLR cameras that will be used in professional or advanced amateur video recording.

### SUMMARY

It is an object of the present invention to provide a device and method to obviate or mitigate at least one of the above-presented disadvantages.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

A first aspect of the present invention is directed to a device for facilitating the rotation of an adjustment ring from a plurality of adjustment rings of a camera lens. The device comprises a tightening ring having an adjustable diameter and a control lever protruding from the tightening ring allowing a user to rotate the adjustment ring of the camera lens along the lens' longitudinal axis.

Optionally, the tightening ring may be made at least in part of elastic material allowing the tightening ring to frictionally engage onto adjustment rings of various sizes.

Optionally, the tightening ring may further comprise at least one opening on its inner surface and a concave plaque inserted through the opening into an inner pocket of the tightening ring. The control lever would then be fixed onto the concave plaque, through the tightening ring. The device may also provide two openings on the inner surface of the tightening ring, one on either side of the control lever.

Optionally, the tightening ring may be made of bendable rigid material further comprising a worm drive attached to the control lever to pull threads on the tightening ring causing the tightening ring to tighten or expand ring's diameter.

Optionally, the tightening ring may be a partial ring made of bendable solid material with a diameter adjusted by clipping the partial ring over the adjustment ring. The tightening ring may further comprise an inner ring attached to the partial ring to improve friction between the tightening ring and the adjustment ring.

A second aspect of the present invention is directed to a method for facilitating the rotation of an adjustment ring from a plurality of adjustment rings of a camera lens. The method comprises enlarging a tightening ring to an extended diameter larger than the diameter of the adjustment ring and positioning the tightening ring onto the adjustment ring of the camera for frictionally engaging the tightening ring onto the adjustment ring. Applying lateral pressure along the camera lens' longitudinal axis onto a control lever protruding from the tightening ring causes the adjustment ring to rotate.

Optionally, the tightening ring may be made at least in part of elastic material.

Enlarging the tightening ring may comprise pulling on two sides of the tightening ring and positioning the lever ring device onto the adjustment ring of the camera for frictionally engaging the tightening ring onto the adjustment ring may comprise allowing the tightening ring to rest onto the adjustment ring.

Optionally, the control lever may be attached to a worm drive. Enlarging the tightening ring comprises rotating the control lever around its longitudinal axis in a first direction and positioning the lever ring device onto the adjustment ring of the camera for frictionally engaging the tightening ring onto the adjustment ring may comprises rotating the control lever around its longitudinal axis in a second direction opposite to the first direction.

Optionally, the tightening ring may be a partial ring. Enlarging the tightening ring may comprise applying an outward force onto the two ends of the partial ring and positioning the lever ring device onto the adjustment ring of the camera for frictionally engaging the tightening ring onto the adjustment ring may comprise allowing it to rest onto the adjustment ring.

### BRIEF DESCRIPTION OF THE DRAWINGS

The detailed description is described with reference to the accompanying figures. The use of the same reference numbers in different instances in the description and the figures can indicate similar or identical items.

FIG. 1 shows an exemplary kit of parts in accordance with the present invention;

FIG. 2 shows an intermediate state of an exemplary assembly method in accordance with the present invention;

FIG. 3 shows another intermediate state of an exemplary assembly method in accordance with the present invention;

FIG. 4 shows an exemplary device in accordance with the present invention;

FIG. 5 shows the exemplary device of FIG. 4 installed on an exemplary camera lens;

FIGS. 6A, 6B and 6C together referred to as FIG. 6 show an exemplary kit of parts in accordance with the present invention; and

FIG. 7 shows another exemplary device in accordance with the present invention.

### DETAILED DESCRIPTION

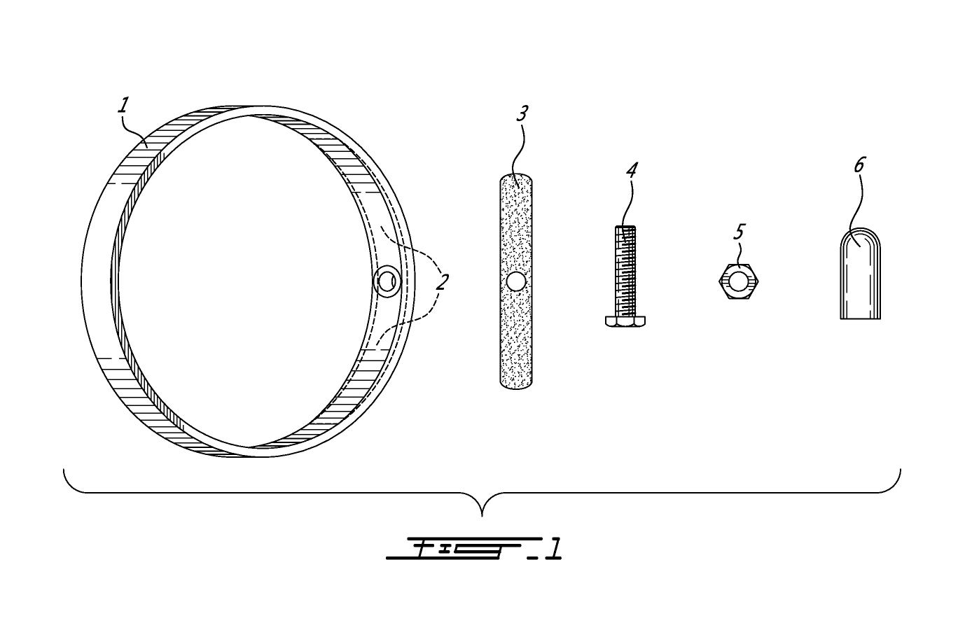

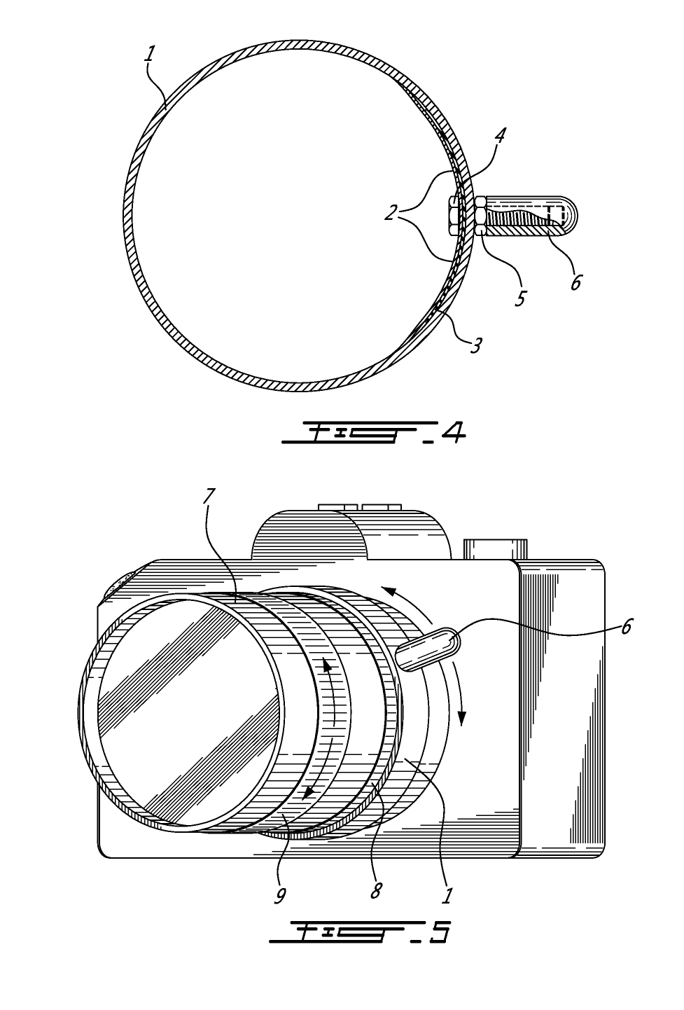

Reference is now concurrently made to FIGS. 1 to 7 of the drawings. In one embodiment, a tightening ring of a device may be made in part or in full of elastic material such as rubber which can expanded while installing the device and then contract to tightly fit onto adjustment rings of different sizes. Friction between the tightening ring and the adjustment ring transfers the rotational force from a control lever of the tightening ring to the adjustment ring of the lens thus providing control of the zoom or focus adjustment ring through the control lever. One or two openings may be provided on the inner side of the tightening ring in order to insert a concave plaque (e.g., metallic plaque). The concave plaque can then be used as a support for the control lever. In this scenario, the control is attached to the concave plate and protrudes through the tightening ring. When two openings are used, they are placed on each side of the control lever and each one of them holds one portion of the concave plaque.

Alternatively, the tightening ring may be made of rigid material that bends under pressure. In this scenario, the control lever is also used to control the pinion of a worm drive that pulls threads on the tightening ring. As a result, the tightening ring's diameter expands or tightens as the tightening ring twists onto itself as the control lever is turned clockwise or counter-clockwise.

As yet another alternative, the tightening ring can be a partial ring such as an arc of more than 180 degrees (e.g., 270 degrees) made of rigid material that bends under pressure but recovers its natural shape at rest. In this scenario, the device is mounted by applying a force on each end of the partial ring in order to force it open and expand its diameter. Once in place, the tightening ring is left to rest and clips onto the adjustment ring of the camera lens.

This invention aims at improving the ergonomics and ease of use of cameras (e.g., SLRs) by allowing the user to adjust both adjustment rings with one hand (e.g., without moving their left hand). The present invention, while it applies in various contexts, appears to be particularly suited to cameras available, in some cases, since 2008 that offer video capabilities in addition to traditional photographic options. The device mounts onto the focus or the zoom adjustment ring of the camera lens and provides a lever that facilitates the rotation of these rings. The user operates a lever on the zoom-control device (e.g., with their left thumb) and can simultaneously operate the focus ring (e.g., with their left index finger). The invention thereby allows users to rapidly make dual adjustments to the zoom and focus (e.g., of a video image), something which is likely impossible given the current configuration and ergonomics of cameras equipped with a zoom lens.

The tightening ring of the present invention is designed to be removable and reusable from one camera lens to another with the different camera lenses possibly having different diameters.

It is possible to provide a device that improves the ergonomics and can easily be mounted onto most camera lenses available. FIG. 1 shows an elastic tightening ring 1, which can be made of rubber with a shaped internal opening 2, a concave metal plaque 3 of corresponding width, a screw 4, a nut 5, and a control lever 6 that can be screwed along the screw 4. A hole of corresponding circumference as the screw 4 and the nut 5 is provided between the internal opening 2 of the rubber ring 1 and in the center of the concave metal plate 3.

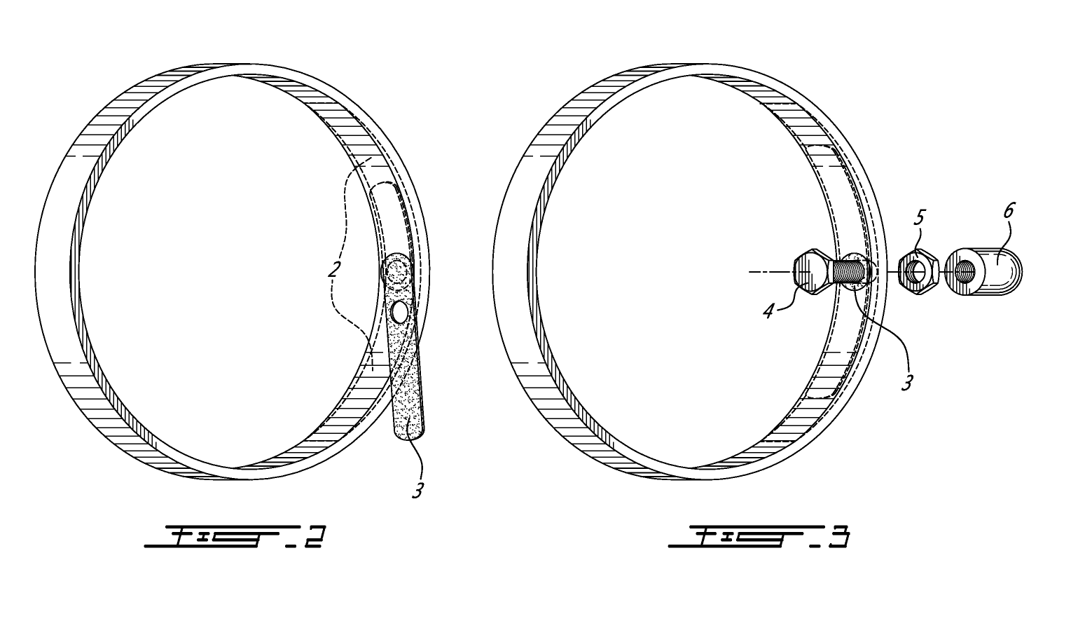

The invention may be assembled as follows: the two ends of the concave metal plaque 3 are inserted into the internal opening 2 of the tightening ring 1 (as can be seen on FIG. 2). Next, the screw 4 is inserted from the interior through holes in the concave plaque 3 and the tightening ring 1. Nut 5 is then fixed to screw 4 on the outside of the tightening ring 1. Finally, the control lever 6 is screwed onto the protruding section of the screw 4 (as can be seen on FIG. 3). Once fixed in place, the lever is perpendicular to the focus and zoom rings of the lens (as can be seen on FIG. 4).

Once the tightening ring 1 of the invention is mounted onto the zoom adjustment ring or the focus adjustment ring (8 or 9) of the camera lens 7, the lever 6 is pushed up or down (e.g., with the left thumb) in order to rotate the adjustment riong 8 or 9 to which it is affixed. At the same time, the focus ring 9 can also be controlled (e.g., with the left index finger).

The screwing of the lever to the tightening ring 1 and concave metal plaque 3 provides the exemplary advantage of increased stability of the device over the adjustment ring. Although one opening 2 is enough, a preferred embodiment uses two opening 2 into which each end of the concave plaque 3 is inserted.

The opening 2 and the concave plaque 3 are however optional, as another exemplary embodiment of the device (not shown) is functional, although it may be more fragile, with a control lever attached directly to the tightening ring, either by being molded as a single part with the tightening ring, fused to the external surface of the tightening ring, or attached to the interior of the tightening ring by the means of a screw without the metal plaque (e.g., by properly dimensioning the screw head (symmetrically or asymmetrically) to provide sufficient stability).

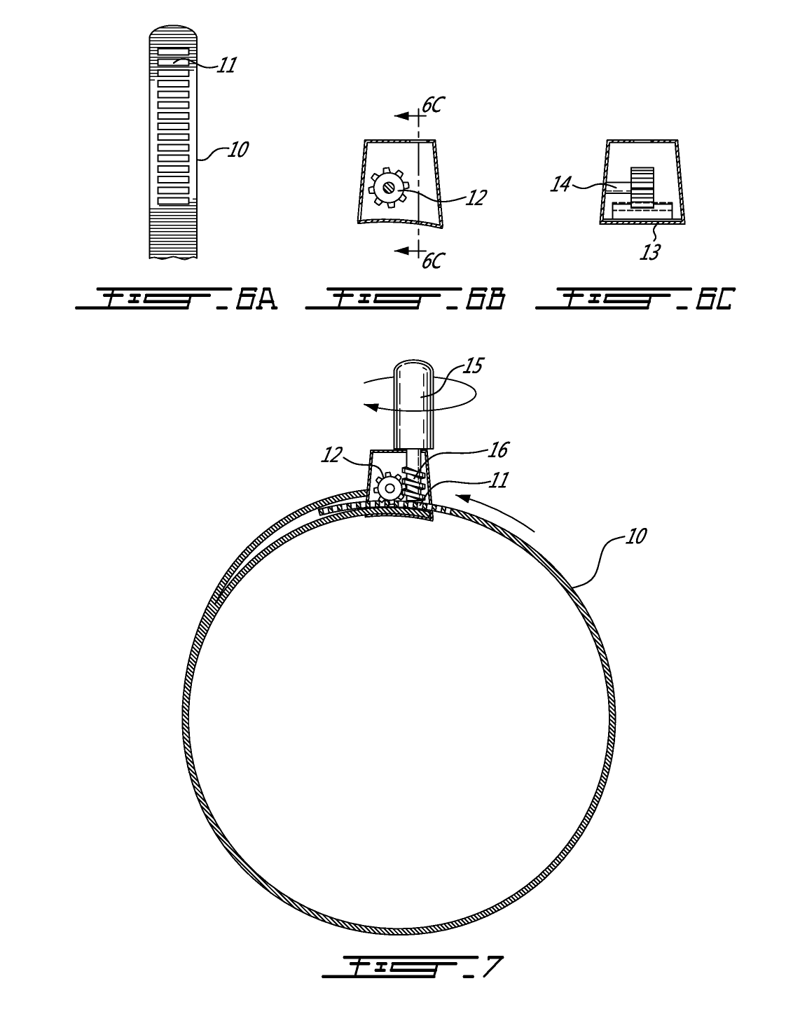

Another embodiment of the present invention uses a tightening ring 10 that is made of metal material, plastic material or another suitable material that is flexible enough to wrap onto itself over the adjustment ring without kinking. Such a tightening ring 10 is rigid, but may still bend under pressure allowing it to wrap onto itself. In this embodiment, as illustrated on FIGS. 6 and 7, a control lever 15 is used as a worm drive in conjunction with a worm gear 12. The worm drive is used to pull threads 11 of the tightening ring 10. As the threads 11 are being pulled, the tightening ring 10 wraps onto itself. Consequently, turning the control lever 15 around its longitudinal axis clockwise or counter-clockwise results in the tightening ring's diameter to contract or extend. Tightening the tightening ring 10 onto the adjustment ring 8 or 9 of the camera lens frictionally engages the device and allows the adjustment ring 8 or 9 to be rotated using the control lever 15.

Another embodiment consists in using a tightening ring made of solid metal or another suitable material that bends but recovers its shape at rest. A partial tightening ring (not shown) of more than 180 degrees (e.g., 270 degrees) is used instead of a full 360 degree ring. Greater or smaller arc angles may be used depending on the malleability of the material used for the tightening ring. In this embodiment, the pressure exercised by the partial ring onto the adjustment ring 8 or 9 causes the friction engagement. In this embodiment, attaching an inner ring made of rubber into the partial ring may further improve the friction between the tightening ring and the adjustment ring.

The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

What is claimed is:

1. A device for facilitating the rotation of an adjustment ring from a plurality of adjustment rings of a camera lens comprising:
a tightening ring having an adjustable diameter; and
a control lever protruding from the tightening ring allowing a user to rotate the adjustment ring of the camera lens along the lens' longitudinal axis.

2. The device of claim 1, wherein the tightening ring is made at least in part of elastic material allowing the tightening ring to frictionally engage onto adjustment rings of various sizes.

3. The device of claim 1, wherein the tightening ring further comprises:
at least one opening on its inner surface; and
a concave plaque inserted through the opening into an inner pocket of the tightening ring,
wherein the control lever is fixed onto the concave plaque, through the tightening ring.

4. The device of claim 3, wherein two openings are used on the inner surface of the tightening ring, one on either side of the control lever.

5. The device of claim 1, wherein the tightening ring is made of bendable rigid material further comprising a worm drive attached to the control lever to pull threads on the tightening ring causing the tightening ring to tighten or expand ring's diameter

6. The device of claim 1, wherein the tightening ring is a partial ring made of bendable solid material with a diameter adjusted by clipping the partial ring over the adjustment ring.

7. The device of claim 6, wherein the tightening ring further comprises an inner ring attached to the partial ring to improve friction between the tightening ring and the adjustment ring.

8. A method for facilitating the rotation of an adjustment ring from a plurality of adjustment rings of a camera lens comprising:
enlarging a tightening ring to an extended diameter larger than the diameter of the adjustment ring; and
positioning the lever ring device onto the adjustment ring of the camera for frictionally engaging the tightening ring onto the adjustment ring,
wherein applying lateral pressure along the camera lens' longitudinal axis onto a control lever protruding from the tightening ring causes the adjustment ring to rotate.

9. The method of claim 8, wherein the tightening ring is made at least in part of elastic material and wherein enlarging the tightening ring comprises pulling on two sides of the tightening ring and positioning the lever ring device onto the adjustment ring of the camera for frictionally engaging the tightening ring onto the adjustment ring comprises allowing the tightening ring to rest onto the adjustment ring.

10. The method of claim 8, wherein the control lever is attached to a worm drive and wherein enlarging the tightening ring comprises rotating the control lever around its longitudinal axis in a first direction and positioning the lever ring device onto the adjustment ring of the camera for frictionally engaging the tightening ring onto the adjustment ring comprises rotating the control lever around its longitudinal axis in a second direction opposite to the first direction.

11. The method of claim 8, wherein the tightening ring is a partial ring and wherein enlarging the tightening ring comprises applying an outward force onto the two ends of the partial ring and positioning the lever ring device onto the adjustment ring of the camera for frictionally engaging the tightening ring onto the adjustment ring comprises allowing it to rest onto the adjustment ring.
